(19) United States
(12) Patent Application Publication
(10) Pub. No.: US 2022/0297641 A1
(43) Pub. Date: Sep. 22, 2022

(54) STABILIZING JACK

(71) Applicant: LIPPERT COMPONENTS, INC., Elkhart, IN (US)

(72) Inventor: Michael W. Nebel, Smith Center, KS (US)

(21) Appl. No.: 17/685,748

(22) Filed: Mar. 3, 2022

Related U.S. Application Data
(60) Provisional application No. 63/163,439, filed on Mar. 19, 2021.
(60) Provisional application No. 63/210,310, filed on Jun. 14, 2021.

(51) Int. Cl. B60S 9/06; B66F 3/12

(52) U.S. Cl. CPC B60S 9/06; B66F 3/12

(57) ABSTRACT

A stabilizing jack includes a base securable to a vehicle frame with a drive screw rotatably mounted to the base and a screw follower threadingly secured to the drive screw. A length adjustable lift leg is pivotally connected at an upper end to the screw follower. A stabilizing member is pivotally connected at a first end to the base inward from the screw follower. The lift leg is pivotally connected at an outer end to the stabilizing member. Downward extension of the lift leg through outward advancement of the screw follower on the screw and downward pivoting of the lift leg by the stabilizing member advances the foot into the ground to raise the vehicle frame relative to the suspension. The extended lift leg and stabilizing member form a triangle with the base providing resistance to lateral movement of the vehicle frame relative to the wheels and suspension.

### CROSS-REFERENCES TO RELATED APPLICATIONS

This application claims the benefit of U.S. Provisional Patent Application Ser. No. 63/163,439, filed Mar. 19, 2021, and U.S. Provisional Patent Application Ser. No. 63/210,310, filed Jun. 14, 2021, the entire content of each of which is herein incorporated by reference.

### STATEMENT REGARDING FEDERALLY SPONSORED RESEARCH OR DEVELOPMENT

(NOT APPLICABLE)

### BACKGROUND

This invention relates to stabilizing jacks for recreational vehicles adapted to raise the recreational vehicle relative to its suspension to provide stability to the vehicle when parked.

A wide variety of stabilizing jacks have been developed for use in stabilizing recreational vehicles, trailers and the like when parked by raising the vehicle relative to its suspension system to prevent rocking and swaying of the recreational vehicle as an occupant moves around in the vehicle. For example, U.S. Pat. No. 4,103,869 to Mesny et al. discloses a stabilizing system utilizing four separate jacks mounted in the corners of the vehicle with each jack having a separate gear/motor for extending and retracting the leg of the jack. An inner, upper end of the leg of each jack is mounted on a trunnion which rides on a worm gear or screw supported in a channel beam. A foot is connected to the outer, opposite end of the jack leg and support arms or linkages are pivotally connected between a medial portion of the leg and the distal end of the channel beam. Rotation of the screw in a first direction, drives the trunnion and the upper end of the jack leg outward along the screw and the connection of the support linkages between the jack leg and the distal end of the channel beam causes the outer, opposite end of the leg to pivot downward to the ground.

U.S. Pat. No. 6,827,335 to Medberry and U.S. Pat. No. 7,249,754 to Garceau et al. disclose similarly constructed jack legs with the upper, inner end of each jack leg mounted on a trunnion or block which rides on a worm gear or screw. Linkages pivotally connected between a medial portion of each jack leg and a channel beam restrict the movement of the leg causing it to pivot downward as the trunnion or block on which the upper end of the jack leg is mounted is moved outward.

In each of these systems when the jack leg is lowered to lift and stabilize the trailer, a significant portion of the load from the trailer is transmitted through the linkages. Excessive loading of the trailer can cause bending of the jack leg where it connects to the linkages, the linkages may bend or the pins connecting the linkages may fail.

There remains a need for a lightweight stabilizing jack for travel trailers or campers that provides improved stability of the travel trailer.

### SUMMARY

The described embodiments are directed to stabilizing jacks for use with vehicles and are particularly well adapted for use with recreational vehicles including travel trailers. In one aspect of the described embodiments, the stabilizing jack includes a telescoping or length adjustable lift leg pivotally connected proximate an upper end to a lift leg pivot mount. The pivot mount may be fixed relative to a vehicle frame or formed as a screw follower for moving laterally relative to a drive screw mounted to the vehicle frame. A stabilizing member is pivotally securable at a first end to a stabilizing member mount securable to the vehicle frame inward from the lift leg pivot mount. The stabilizing member is pivotally connected at a second end to a lower end of the lift leg. A foot is mounted on a second end of the lift leg or stabilizing member or both and adapted to engage the ground. When the lift leg is extended, the foot engages the ground, and further extension of the lift leg raises the vehicle frame relative to the suspension connecting the frame to a wheel. The extended lift leg and stabilizing member generally form a triangle with the vehicle frame or a base of the jack with portions of the lateral forces acting on the vehicle through the stabilizing member providing resistance to lateral movement of the frame and vehicle.

The stabilizing jack may also comprise a base securable to the vehicle frame and having inner and outer ends. A drive screw is rotatably mounted to the base and a screw follower is threadingly secured to the drive screw for linear advancement of the screw follower longitudinally relative to the drive screw upon rotation of the drive screw clockwise or counterclockwise. A length adjustable or telescoping lift leg assembly is pivotally connected at an upper end to the screw follower. A stabilizing member is pivotally connected at a first end to the base inward from the screw follower. The lift leg is pivotally connected at an outer end to the stabilizing member. The length adjustable lift leg may include first and second telescoping members and means for selectively fixing the length of the telescoping members. Downward extension of the lift leg through lateral and outward advancement of the screw follower on the drive screw and downward and inward pivoting of the lift leg by the stabilizing member advances the foot into the ground to raise the vehicle frame relative to the suspension. The extended lift leg and stabilizing member form a triangle with the base with the triangular configuration of two laterally aligned trailer jacks providing resistance to lateral movement of the vehicle frame relative to the wheels and suspension.

The drive screw of the stabilizing jack may be rotated manually using a hand tool or by a motor drivingly coupled or coupleable to the drive screw and operable to rotate the drive screw clockwise and counterclockwise. The motor may be drivingly coupled to an end of the drive screw extending proximate the outer end of the base with a switch mounted on the base proximate the outer end thereof that is operably coupled to the motor and a power source. The switch is spring biased to normally advance to an off position in which power is not supplied to the motor from the power source. The switch is selectively advanceable to a first power supply position in which power is supplied to the motor from the power source to rotate the drive screw in a first direction and to a second power supply position in which power is supplied to the motor from the power source to drive the drive screw in a second direction.

The motor may be an electric motor electrically coupleable to a battery on a vehicle on which the jack is mounted. The motor is preferably coupled to the drive screw such that an axis of rotation of the motor extends approximately perpendicular to the axis of rotation of the drive screw, and the switch is mounted on an outer end of the base. Mounting the switch on the outer end of the base simplifies the required wiring for providing power to the motor and eliminates the need to cut holes in the sidewalls or floor of the trailer or vehicle to mount the switch or run wiring.

The transverse mounting of the motor relative to the drive screw and the mounting of the switch on the end of the base may be used with a stabilizing jack similar to the jack described previously except that both the lift leg and the stabilizing leg are of fixed lengths.

### BRIEF DESCRIPTION OF THE DRAWINGS

These and other aspects and advantages will be described in detail with reference to the accompanying drawings, in which:

FIG. 1 is a perspective view of a trailer with four stabilizing jacks shown secured to frame members of the trailer;

FIG. 2 is an exploded, top, perspective view of one of the trailer jacks as shown in FIG. 1 shown secured to a portion of the trailer frame;

FIG. 3 is an exploded, bottom, perspective view of the stabilizing jack as shown in FIG. 2 shown secured to a portion of the trailer frame;

FIG. 4 is a side view of the stabilizing jack as shown in FIG. 2 shown secured to a portion of the trailer frame;

FIG. 5 is a bottom plan view of the stabilizing jack as in FIG. 2 shown secured to a portion of the trailer frame;

FIG. 6 is an enlarged and fragmentary, cross-sectional view of the stabilizing jack taken along line 6-6 of FIG. 4;

FIG. 7 is an enlarged, exploded and fragmentary perspective view of a portion of the stabilizing jack as shown in FIG. 3 including a drive screw, screw follower and lift leg of the jack;

FIG. 8 is a perspective view of an alternative embodiment of a stabilizing jack shown secured to a portion of a vehicle frame;

FIG. 9 is a side elevational view of the stabilizing jack as shown in FIG. 8;

FIG. 10 is a cross-sectional view taken along line 10-10 of FIG. 8;

FIG. 11 is an enlarged, exploded and fragmentary perspective view of a portion of the stabilizing jack as shown in FIG. 10 showing a drive screw, screw follower and lift leg of the stabilizing jack with portions removed to show detail thereof;

FIG. 12 is a top, perspective view of an alternative embodiment of a stabilizing jack secured to a portion of a trailer frame;

FIG. 13 is a bottom, perspective view of an alternative embodiment of a stabilizing jack secured to a portion of a trailer frame;

FIG. 14 is a rear plan view of the stabilizing jack of FIG. 12 shown secured to a portion of a vehicle frame with the stabilizing jack in a raised position;

FIG. 15 is a rear plan view of the stabilizing jack of FIG. 12 shown secured to a portion of a vehicle frame with the stabilizing jack in a lowered, lifting and stabilizing position;

FIG. 16 is left side, top, perspective view of an alternative embodiment of a stabilizing jack secured to a portion of a trailer frame; and

FIG. 17 is a right side, top, perspective view of the stabilizing jack secured to a trailer frame as in FIG. 16.

### DETAILED DESCRIPTION

Detailed embodiments are disclosed herein; however, it is to be understood that the disclosed embodiments are merely exemplary, which may be embodied in various forms. Therefore, specific structural and functional details disclosed herein are not to be interpreted as limiting, but merely as a basis for the claims and as a representative basis for teaching one skilled in the art to variously employ the described embodiments in virtually any appropriately detailed structure. The drawings constitute a part of this specification and include exemplary embodiments and illustrate various objects and features thereof.

Certain terminology will be used in the following description for convenience in reference only and will not be limiting. For example, the words “upwardly,” “downwardly,” “rightwardly,” and “leftwardly” will refer to directions in the drawings to which reference is made. The words “inwardly” and “outwardly” will refer to directions toward and away from, respectively, the geometric center of the embodiment being described and designated parts thereof. The terminology will include the words specifically mentioned, derivatives thereof and words of a similar import.

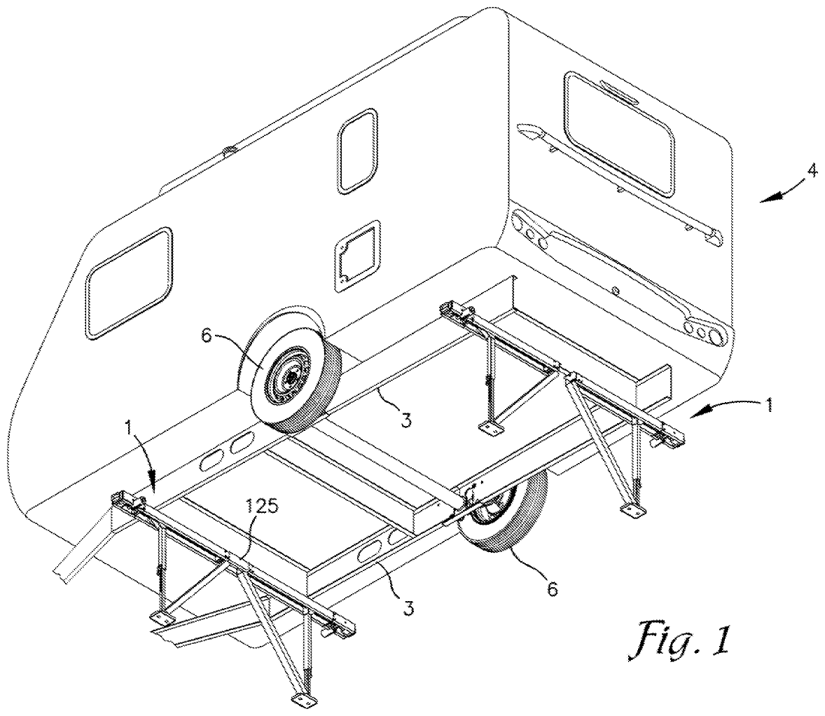

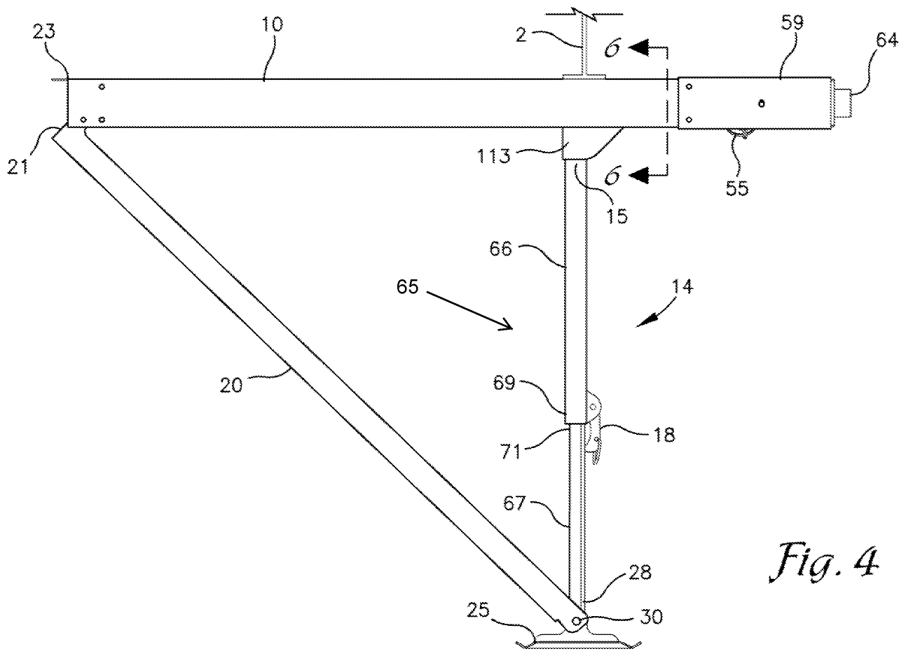

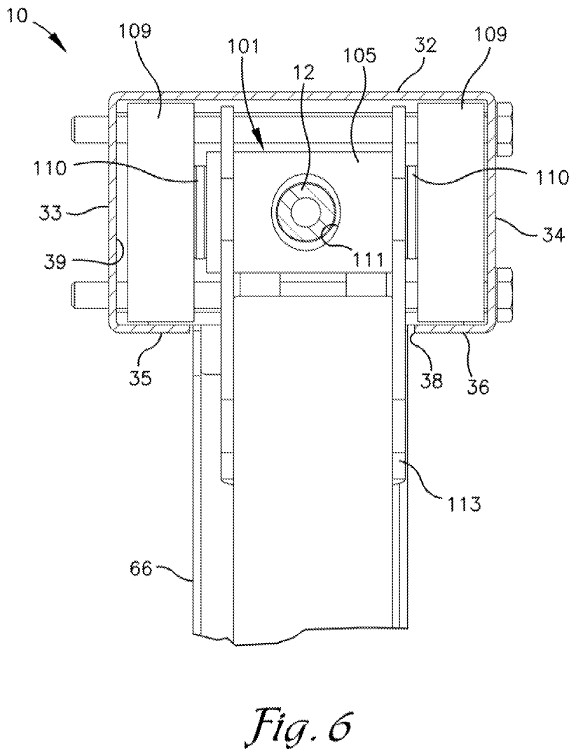

Referring to the drawings in more detail, and in particular FIGS. 1-7, reference numeral 1 refers to a stabilizing jack which is adapted to be secured to frame members of a recreational vehicle such as left or right frame members 2 or cross-members or lateral frame members 3 of a travel trailer 4. Directional references included herein are in reference to the stabilizing jack 1 secured to the frame members of a travel trailer 4 when parked on a horizontal surface. The vehicle/travel trailer 4 is supported on a spring suspension system not shown connected to wheels 6. The suspension system is adapted to provide a smooth ride during travel. However, when the recreational vehicle 4 is parked, the suspension system allows the vehicle 4 to rock back and forth and bounce up and down relative to the wheels 6 as passengers move around in the vehicle 4.

The stabilizing jack 1 is adapted for raising the vehicle 4 upward relative to the wheels 6 to take some of the weight of the vehicle off the suspension system to stabilize the vehicle 4 and prevent rocking and bouncing of the parked vehicle 4. For travel trailer type recreational vehicles 4, as shown in FIG. 1, one stabilizing jack 1 is mounted proximate each corner of the travel trailer, namely the front left and front right corners and the rear left and rear right corners, to stabilize the trailer 4 against lateral movement. It is foreseen that if properly sized, the jacks 1, mounted in the corners of the travel trailer 4 could be used for leveling the recreational vehicle 4. However, the vehicle 4 is preferably parked on level ground such as a level pad prior to stabilization and does not require significant leveling.

Each stabilizing jack 1 comprises a base or track 10, a drive screw or worm gear 12 rotatably mounted to the base 10, a lift leg 14 pivotally connected at an inner end 15 to a screw follower assembly 18 which is threadingly coupled to the screw 12, a stabilizing member or brace 20 pivotally connected at an inner end 21 thereof to an inner end 23 of the base 10 and having a foot 25 pivotally mounted on an outer end 26 of the stabilizing member 20. A distal or outer end 28 of the lift leg 14 is pivotally connected to the stabilizing member 20 in outwardly spaced relation from the pivotal connection between the inner end 21 of the stabilizing member and the inner end 23 of the base channel 10. In the embodiment shown, the outer end 28 of the lift leg 14 is pivotally connected to a pivot pin 30 pivotally connecting the foot 25 to the outer end 26 of the stabilizing member 20. The lift leg 14 may be described as being pivotally connected at its outer end 28 to the distal end of the stabilizing member 20.

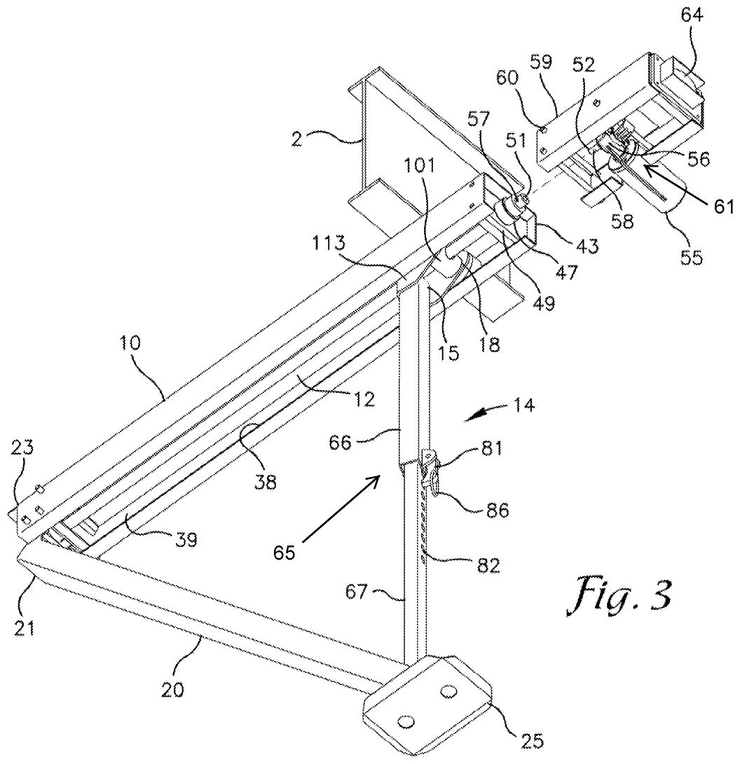

As best seen in FIGS. 3, 5 and 6, the base 10 may be formed from an elongated, downwardly opening C-channel comprising a web 32, downwardly extending sidewalls 33 and 34 and inwardly extending track flanges 35 and 36 with a guide slot 38 extending therebetween and opening to an interior space or channel 39. The base 10 may also be referred to as a track, base channel, track channel, beam or cross beam. A plurality of mounting holes 41 are formed through the web 32 of the base channel 10 in spaced relationship inward from an outer end 43 of the base channel 10 in a spacing selected to allow bolting the base channel 10 onto a frame member 2 of the vehicle 4 to which it is to be attached. One or more additional mounting holes 42 are formed in the web 32 proximate the inner end 27 of base channel 10 to allow the inner end of the base channel 10 to be bolted to an interior frame member or structure not shown. The base channel 10 is preferably mounted on the respective frame member 2 so that the base channel 10 extends perpendicular to the frame member 2 and in planar alignment with a bottom surface of the frame member 2 so that the base extends generally horizontal when the vehicle 4 is parked on level ground. It is to be understood that the base 10 could be formed from multiple components which are not coupled together and separately securable to the vehicle frame 2. As used herein, the outer end 43 of the base channel 10 is the end adapted to be positioned closest to or toward the side of the vehicle 4 to which the jack 1 is attached with the inner end 23 of base channel 10 positioned inward relative thereto under the vehicle 4.

The drive screw 12 is rotatably mounted lengthwise within the base channel 10 or in axial alignment therewith and supported on first and second or inner and outer bearings 46 and 47 mounted on inner and outer bearing plates 48 and 49 respectively secured within the base channel 10 proximate opposite ends thereof. The inner bearing plate 48 extends across the interior space 39 of base channel 10 proximate the inner end 27 thereof and the outer bearing plate 49 extends across the interior space 39 of base channel 10 proximate the outer end 43 thereof. An outer end of the drive screw 12 has a drive socket 51 formed therein which is sized and shaped to receive a matingly shaped driver of a hand tool (not shown) or a matingly shaped driver 52 drivingly connected to the drive shaft of a motor 55 by a gear assembly housed in a gear box 56 connected to the motor 55.

In some embodiments, the motor is an electric motor 55 but it is foreseen that a hydraulic motor or motors powered by other means could be utilized. In the embodiment shown, the drive socket 51 is circular in cross-section and the drive socket 51 and the driver 52 each include a pin receiving hole 57 and 58 respectively for pinning the driver 52 in the socket 51. It is foreseen that the drive socket 51 and driver 52 may each have a square or hexagonal mating cross-section. The socket 51 preferably is formed in a shape or size corresponding the generally available tools such as socket drivers. Matingly shaped, drive adaptors (not shown) may also be pinned to the drive socket 51 and driver 52 shown to allow driving engagement of the driver 52 relative to the drive socket 51 without having to pin the two together. It is also foreseen that a driver may be connected to the drive socket 51 or formed on the end of the screw 12 to receive a drive socket of a hand tool or a drive socket connected to the output shaft of a motor.

The jack 1 may be sold or provided with or without the motor 55. In some embodiments, the motor 55 is supported on a separate motor mount, mounting bracket or channel 59 which is securable onto the end of the base channel 10 if the jack 1 is to be sold with the motor 55 or if the motor 55 is to be later added as an after-market part. It is to be understood that the base channel 10 could be formed longer to include a section for supporting the motor 55 in close proximity to the drive screw 12 so that the driver 52 can be drivingly connected to the drive socket 51 of the drive screw 12. The mounting bracket 59 may be formed from a section of a C-channel that is slightly narrower or wider than the C-channel forming the base channel 10 so that an inner end of the mounting bracket 59 may be slid into or over the outer end 43 of the base channel and connected thereto using bolts 60 or other acceptable fasteners.

The motor 55 may be mounted to the mounting bracket so that the matingly shaped end of the driver 52 slides into the drive socket 51 in the end of the drive screw 12 when the mounting bracket 59 is slid onto the base channel 10. In the embodiment shown, the driver 52 and its rotational axis extend transverse to the motor 55 and its rotational axis. The motor 55 is mounted to the mounting bracket 59 so that the rotational axis of the motor extends transverse to the rotational axis of the drive screw 12. In the embodiment shown, a notch 61 is formed in one of the sidewalls of the mounting bracket 59 with a portion of the motor 55 extending therethrough. A motor mounting bolt may be secured to sides of the mounting bracket 59 and through a receiver 63 projecting from the gear box 56 to hold the motor 55 in place secured to the mounting bracket 59. In one embodiment, the gear assembly utilized is a worm gear type assembly which resists or prevents inadvertent rotation or back drive of the drive shaft and driver 52 when power is not supplied to the motor 55.

A three-position switch 64 is shown mounted across an outer end of the mounting bracket 59 and the switch 64 may be electrically connected between the electric motor 55 and a battery (not shown) on the frame of the travel trailer 4. The wiring may run between the switch 64, motor 55 and battery by extending along the base channel 10 of the jack 1 and the trailer frame 2 without the need to run the wiring trough the body of the trailer to connect with a switch mounted on a wall of the trailer. The switch 64 may toggle between an off position in which the motor 55 is not electrically connected to the battery, an extension position in which the motor 55 is electrically connected to the battery so that the driver 52, the drive shaft and the drive screw 12 rotate in a first direction (clockwise or counterclockwise) driving the screw follower 18 outward, and a retraction position in which the motor 55 is electrically connected to the battery so that the driver 52, the drive shaft and the drive screw 12 rotate in a second direction (counterclockwise or clockwise), in reverse of the first direction, driving the screw follower 18 inward. The switch 64 is preferably spring biased to normally advance to the off position.

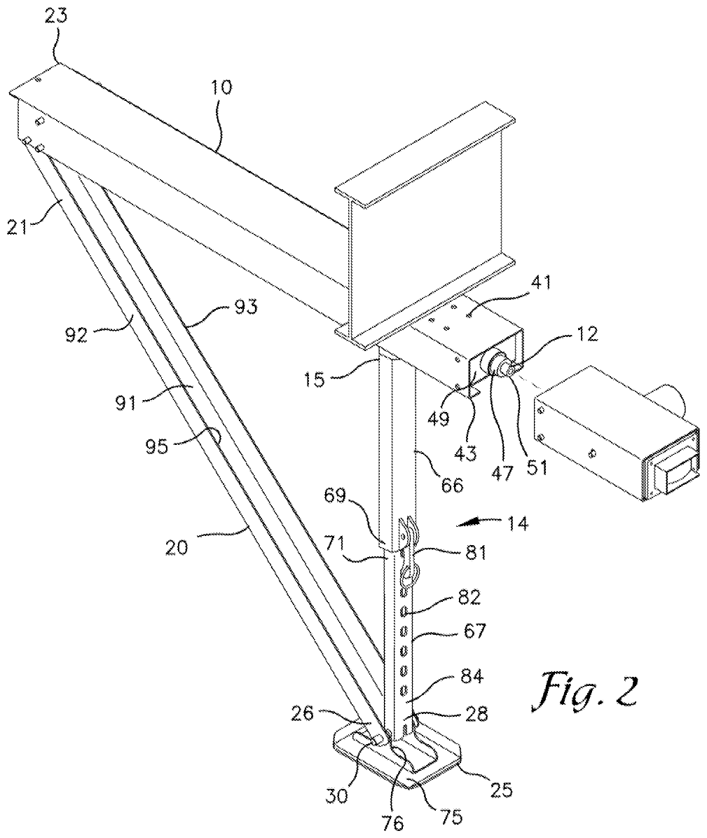

In some embodiments, the lift leg 14 comprises a length adjustable, telescoping leg assembly 65 formed from first and second telescoping segments 66 and 67 which may be formed from tubing, channel members or a combination of a rectangular tube and channel member as shown. In the embodiment shown in FIGS. 2 and 3, the first telescoping segment 66 is formed as a rectangular tube and is pivotally connected at its first end 15 (corresponding to the inner end 15 of lift leg 14) to the screw follower 18. A second end 69 of the first telescoping segment 66 slidingly receives therein a first end 71 of the second telescoping segment 67. A second end 28 of the second telescoping segment 67 (corresponding to the second end 28 of the lift leg 14) is pivotally connected to the second or outer end 26 of the stabilizing member 20 where the foot 25 is connected to stabilizing member 20. The foot 25 includes a generally flat pad 75 with a pair of upwardly projecting ears 76 formed centrally on an upper surface of the pad 75. Pivot pin 30 extends through aligned holes in the ears 76 and the second end 28 of second telescoping segment 67 and outer end 26 of the stabilizing member 20 and pivotally connects the foot 25 to the stabilizing member 20 and the lift leg 14. The ears 76 are positioned at the center of the pad 75 so that the pad generally extends horizontally when the foot 25 is suspended above the ground.

A variety of position setting means may be incorporated into the first and second telescoping segments 66 and 67 of the lift leg for selectively fixing the relative telescoped position of the first segment 66 relative to the second segment 67 including a locking pin insertable through aligned holes in the segments 66 and 67, a spring loaded ball detent extending through a hole in the inner segment and selectively positionable in an aligned hole from one of a plurality of spaced apart holes on the outer telescoping segment. In the embodiment shown, a latch pin or pawl 81 is pivotally mounted on the first or outer telescoping segment 66 proximate its second end 69 and on what generally comprises an upper surface thereof. The latch pawl 81 projects past the second end 69 of the first telescoping segment 66 and extends in alignment with a selected one of a plurality of holes 82 formed in a web or face 84 of the second telescoping segment 67 of the lift leg 14. Adjustment of the length of the lift leg 14 by extending or retracting the second segment 67 relative to the first segment 66 increases or decreases the length of the lift leg 14. Pivoting, by gravity, of the pawl 81 into an aligned hole 82 in the web 84 of the second telescoping segment 67, fixes the longitudinal position of the second telescoping segment 67 relative to the first telescoping segment 66 and fixes the length of the lift leg 14.

In the embodiment shown, a ring 86 is secured on an outer end of the pawl 81 and is graspable by a user to pivot the pawl 81 out of the aligned hole 82 to allow adjustment of the telescoped position of the second segment 67 relative to the first segment 66 to adjust the length of the lift leg 14. Upon release of the ring 86, the outer end of the pawl 81 may advance back into an aligned hole 82 in the second segment 67. Other means for pivoting the pawl 81 out of engagement with an aligned hole 82 in web 84 may be utilized and it is foreseen that the pawl 81 may be mounted on the second segment 67 and extend across an upper end 71 thereof and into a hole in the upper segment 66.

A stabilizing member 20 may also be referred to as a stabilizing leg or stabilizing link 20. In the embodiment shown, the stabilizing member 20 is formed from a C-channel with its inner end 21 pivotally connected to the inner end 23 of the base channel 10 and its outer end 26 pivotally connected to the foot 25. The outer end 26 of stabilizing member 20 may also be described as being pivotally connected to the outer end 28 of the lift leg 14. The C-channel forming the stabilizing member 20 includes a web 91 and upwardly projecting legs 92 and 93 formed along opposite edges thereof to form a channel 95 therebetween. The channel 95 is longer and wider than the lift leg 14 such that the lift leg 14 may pivot into the channel 95 of stabilizing member 20 when the lift leg 14 and stabilizing member 20 are pivoted to a retracted position. A stabilizing member 20 is slightly narrower than the guide slot 38 in the base channel 10 so that when the stabilizing member 20 is pivoted to a retracted position, the stabilizing member 20 generally closes off the guide slot 38 providing some protection of the lift leg 14 and screw 12 from the intrusion of water when driving in wet conditions. It is foreseen that the stabilizing member 20 might also be formed as a pair of parallel linkages (without web 91) spaced wider than the lift leg 14 which is secured between the linkages. It is also foreseen hat the stabilizing member 20 could be formed from a tube and the lift leg 14 formed from telescoping channel members so that the tube forming stabilizing member 20 can nest in the channel members of lift leg 14 when both are retracted to a retracted position.

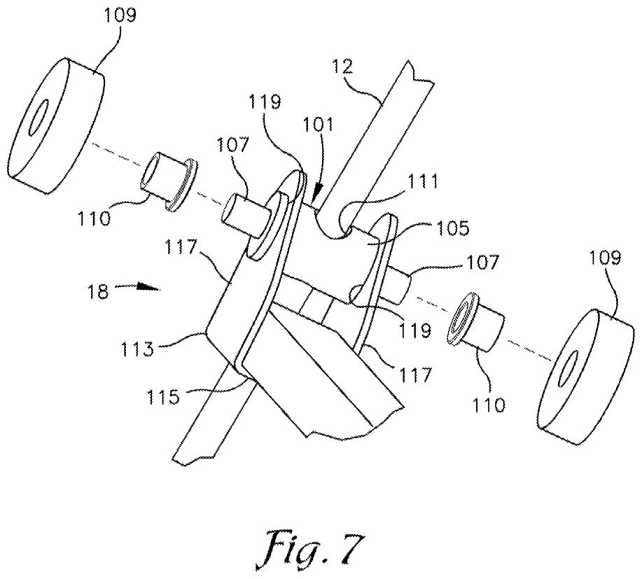

As best seen in FIG. 7, the screw follower assembly 18, of the embodiment shown, includes a trunnion 101 extending around and threadingly connected to the drive screw 12. The trunnion 101 includes a trunnion body 105, stub axles 107 projecting radially outward from each side of the trunnion body 105 and a pair of rollers or wheels 109, each rotatably mounted on a bushing 110 secured on a respective one of the stub axles 107. A threaded bore 111 is formed through the trunnion body 105 with an internal thread sized to mate with a thread of drive screw 12. The drive screw 12 extends through the bore 111 such that the trunnion body 105 may be threadingly advanced along the screw 12. The trunnion 101 is positioned in the interior space 39 of channel member 10. The rollers 109 are spaced apart a distance corresponding to the spacing between the track flanges 35 and 36 so that the rollers 109 roll on the track flanges 35 and 36 with the trunnion body 105 extending in alignment over the guide slot 38. In some embodiments, the drive screw 12 is a triple threaded screw and the trunnion body 105 is similarly threaded with a triple threaded bore 111 which provides more rapid lateral advancement of the trunnion relative to the drive screw 12 upon rotation while requiring less power than a single threaded screw and trunnion body.

In the embodiment shown, the trunnion body 105 is cylindrical. The inner end 15 of the first telescoping segment 66 of lift leg 14 is pivotally connected to the trunnion body 105 by a lift leg mounting bracket 113 fixedly connected to the inner end 15 of lift leg 14. The lift leg mounting bracket 113 is U-shaped and generally formed as a clevis or fork with a central web 115 and outwardly projecting and spaced apart legs 117. Holes 119 are formed through the legs 117 of the bracket 113 and sized slightly wider in diameter than the cylindrical, trunnion body 105. The trunnion body 105 is positioned to extend through the holes 119 so that the mounting bracket 113 and attached lift leg 14 pivot relative to the cylindrical, trunnion body 105.

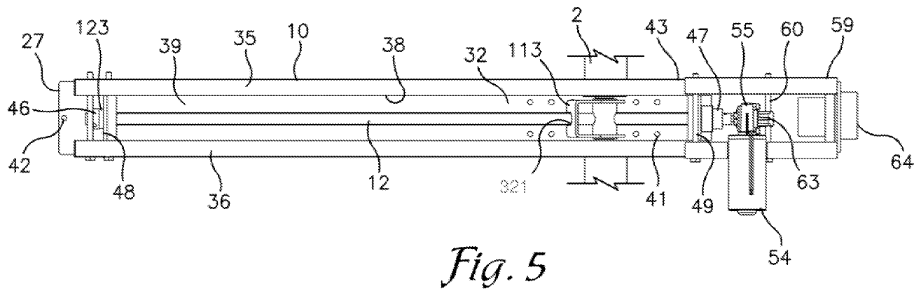

An upwardly opening notch 321 (see FIG. 5) is formed in the web 115 of the mounting bracket 113 so as not to interfere with the drive screw 12 when the lift leg 14 is pivoted from a retracted alignment toward a vertical alignment as it is driven outward by the drive screw 12. In the retracted alignment, the screw follower assembly 18 is driven inward as far as it will go which draws the outer end 28 of the lift leg 14 and the second or outer end 26 of the stabilizing member 20 upward and into the guide slot 38 with the lift leg 14 nested in the channel 95 of the stabilizing member 20. A brake washer 123, formed as an annular disk of resilient material such as rubber, may be positioned around the drive screw 12 between the inner bearing plate 48 and the inner bearing 46 to resist rotation of the drive screw 12 after the lift leg 14 and stabilizing member 20 are advanced to the retracted position. As the screw 12 rotates to draw the trunnion body 105 inward to retract the lift leg 14 and stabilizing member 20, the inner bearing 46 is drawn against the washer 123 and the inner bearing plate 48. The frictional engagement of the face of the inner bearing 46 pressed against the brake washer 123 resists rotation of the inner bearing 46 and attached drive screw 12 thereby resisting reverse rotation of the drive screw 12 and inadvertent lowering of the stabilizing member 20 and lift leg 14 during travel of the trailer 4 particularly on rough roads.

To lower the lift leg 14 and stabilizing member 20, the drive screw 12 is rotated to drive the trunnion 101 outward along the track flanges 35 and 36 which pushes or drives the lift leg mounting bracket 113 and the inner end 15 of lift leg 14 outward. As the trunnion 101 moves outward on the drive screw 12, the pivotal connection of the opposite ends of the stabilizing member 20 to the base channel 10 and the second or outer end 28 of the lift leg 14 causes the outer end 28 of the lift leg 14 to pivot downward increasing the angle between the lift leg 14 and the base channel member 10. Similarly, as the trunnion 101 moves inward on the drive screw 12, the pivotal connection of the opposite ends of the stabilizing member 20 to the base channel 10 and the second or outer end 28 of the lift leg 14 causes the outer end 28 of the lift leg 14 to pivot upward.

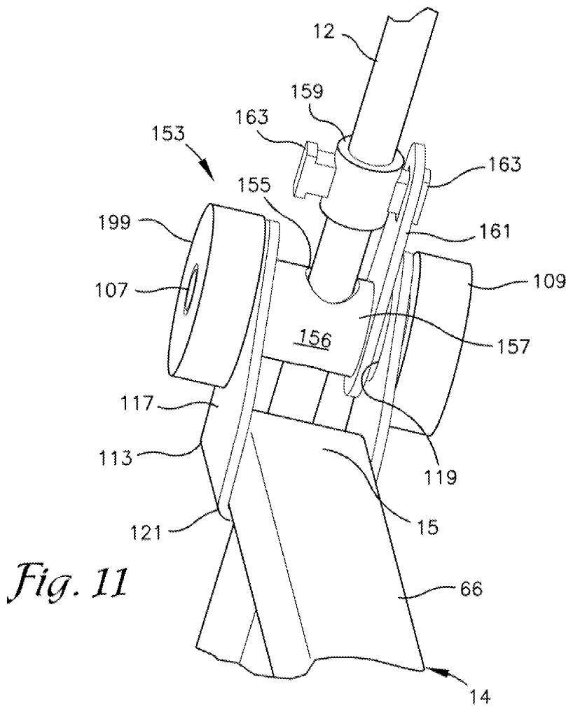

The length of the lift leg 14 is adjustable by telescoping the second segment 67 of the lift leg 14 relative to the first segment 66 and securing the relative position of the segments 66 and 67 using the pivotal latch pawl 81 extended into an aligned pawl receiving hole 82 in the second telescoping segment 67. The length of the lift leg 14 may be adjusted so that the lift leg 14 will extend at an angle of approximately forty-five degrees or greater relative to the base channel member 10 when the foot pad 75 is advanced far enough downward to engage the ground. As the lift leg 14 is pivoted further downward as the screw 12 drives the screw follower assembly 18 further outward, the lift leg 14 begins to lift the frame member 2 of the travel trailer 4 upward to remove the load from the frame member 2 on the vehicle suspension and lift the frame member 2 relative to the wheel 6 proximate the jack 1. The length of the lift leg 14 may be adjusted so that the lift leg 14 will extend approximately vertically below the frame member 2 when the desired amount of lifting of the frame member 2 off the suspension is obtained. In the embodiment shown in FIG. 11, the lift leg 14 is shown extending vertically directly below the frame member 2. The outer bearing plate 49 may be positioned to function as a stop against which an outermost portion of the screw follower assembly 18 abuts when the lift leg 14 is advanced into a desired vertical alignment such as extending approximately vertically under the frame member 2 to which the jack 1 is attached.

The triangle formed between the base channel member 10, the lift leg 14 and the stabilizing member 20 provides a relatively stable structure for supporting the trailer 4 off its suspension. As shown in FIG. 1, the stabilizing members 20 of two laterally aligned stabilizing jacks 1 positioned on opposite sides of the recreational vehicle 4 act in opposition with each other to prevent lateral or side to side movement of the recreational vehicle 4 lifted off its suspension by the jacks 1. Lifting the frame members 2 off the suspension limits bouncing of the travel trailer 4 when occupants move the through the vehicle 4. The stabilizing jacks 1 also function to prevent some fore and aft movement of the vehicle 4, particularly when used in combination with wheel chocks engaging the vehicle wheels 6. The telescoping adjustability of the lift leg 14 facilitates use of the jack 1 with trailers having different spacings of the trailer frame off the ground by the wheels and suspension.

It is foreseen that two laterally aligned jacks 1 could be connected together in a single base or channel member 10 formed from either a continuous channel member 10 or multiple channel members 10 connected together with means for adjusting the length of the channels. For example, a connector channel 125 (as shown in FIG. 1) formed as a C-channel, could include slots formed in its sidewalls at each end for receiving bolts extending through holes in inner ends of the base channels 10 of two opposingly oriented jacks 1 to secure the two jacks together.

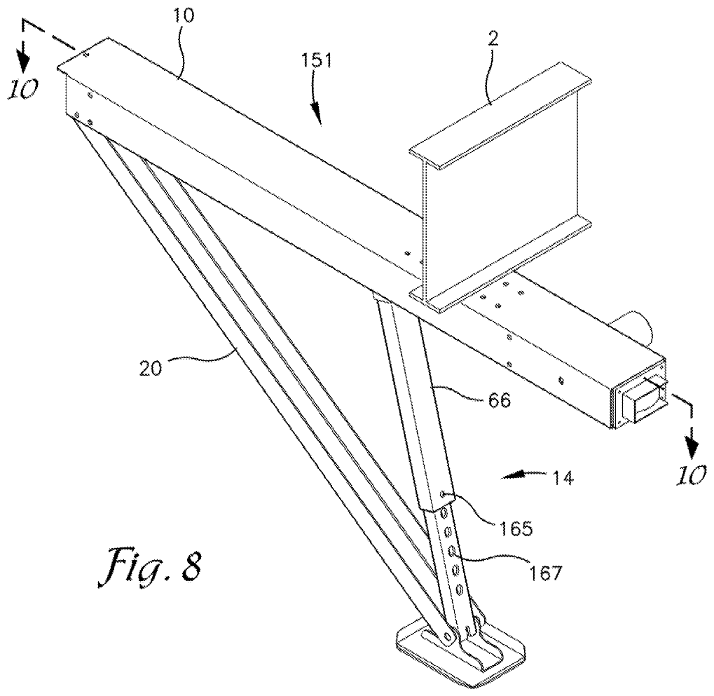

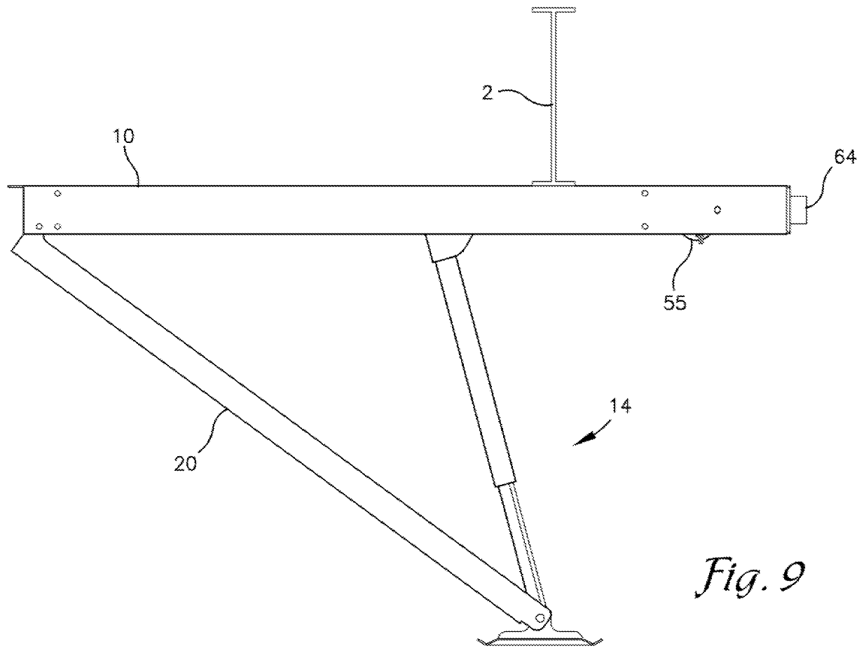

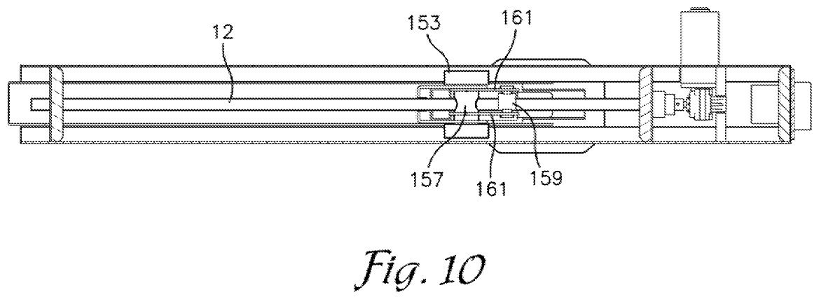

FIGS. 8-11 disclose an alternative embodiment of a stabilizing jack 151. Parts common to jack 1 and jack 151 are generally referred to with the same reference numbers. Referring to FIGS. 10 and 11, jack 151 includes a modified screw follower assembly 153 having a bore 155 formed through the body 156 of a modified trunnion 157 for receiving the drive screw 12. Bore 155 through trunnion body 156 is not threaded and has a diameter that is larger than the outer diameter of the threads of drive screw 12. The drive screw 12 extends through the bore 155 such that the trunnion body 156 advances freely over and along the screw 12.

A threaded nut 159 is threaded onto the drive screw 12 and connected to the trunnion 157 by a pair of straps 161 (one of which is removed in FIG. 11) secured around the trunnion body 156 at one end and connected at opposite ends to ears 163, with enlarged heads, projecting radially outward from the nut 159 on opposite sides thereof. The inner end 15 of the first telescoping segment 66 of lift leg 14 is pivotally connected to the trunnion body 156 by a lift leg mounting bracket 121 fixedly connected to the inner end 15 of lift leg 14. The trunnion body 156 is positioned to extend through the holes 119 in the legs 117 of the mounting bracket 121 so that the mounting bracket 121 and attached lift leg 14 pivot relative to the cylindrical, trunnion body 156.

One advantage of use of the nut 159 with straps 161 connecting the nut 159 to the trunnion body 156 with a bore 155 having a larger diameter than the threads of the screw 12, is that a significant portion of the bending or twisting forces exerted on the trunnion 157 by the lift leg 14 are transmitted through or absorbed by the straps 161 and not by the drive screw 12 reducing the tendency to bend the drive screw 12.

The securement means for telescoping lift leg assembly 14 of the embodiment shown in FIGS. 8-11 has been modified slightly to include a pin mounting receiving hole 165 formed through the tubing forming the first telescoping leg segment 66 and a set of axially aligned pin receiving holes 167 formed through the second telescoping segment 67 in spaced apart relation and in axial alignment with an axis extending through the pin receiving hole 165 in the first telescoping segment 66. A spring-loaded locking pin (not shown) may be mounted in or over the pin receiving hole 165. Extension of the spring-loaded locking pin through the pin receiving hole 165 in first telescoping member 66 and into one of the pin receiving holes 167 aligned therewith in second telescoping member 67 is used to fix the length of the telescoping lift leg 14. As shown in FIGS. 8-10, the base channel 10 is formed long enough to include a space to house a portion of the motor 55 and the gear box 56.

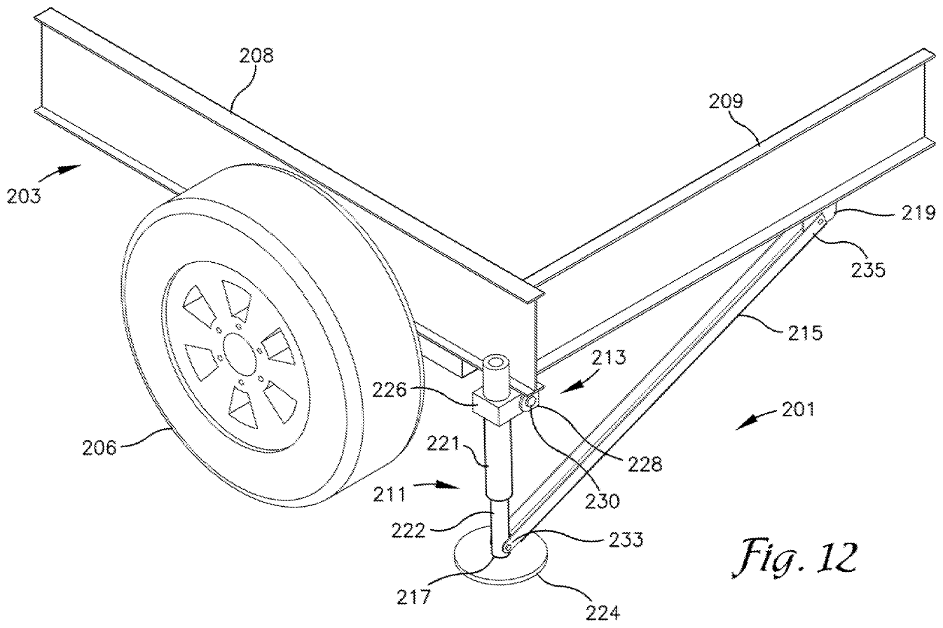

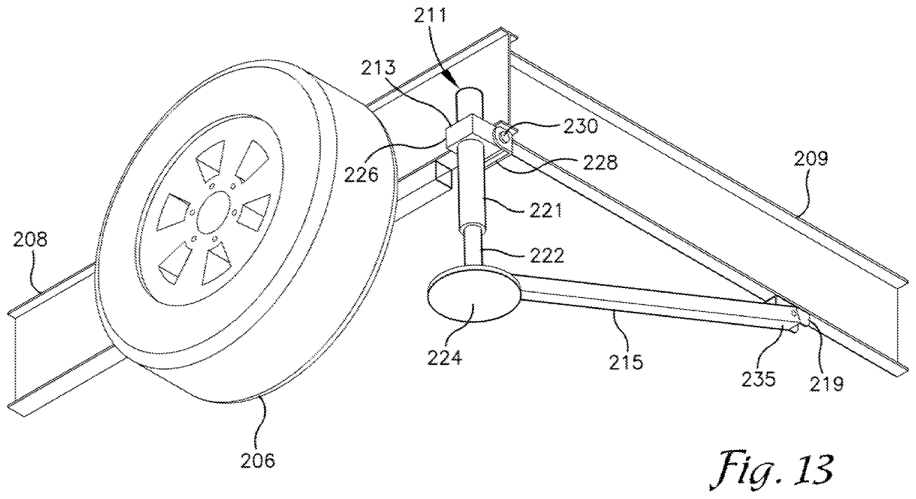

Referring to FIGS. 12-15, a further alternative embodiment of a stabilizing jack assembly 201 is shown which may also be sized to function as a leveling jack to level a recreational vehicle having a vehicle frame 203 supported on wheels 206 by a suspension (not shown). The frame 203 shown, includes side frame members 208 (one of which is shown) and one or more cross-members or lateral frame members 209. Jack assembly 201 includes a telescoping jack or telescoping lift leg assembly 211 pivotally or hingedly connected to a vehicle frame member such as side frame member 208 by pivot mount 213 and a stabilizing member 215 connected to and extending between a lower end 217 of the lift leg assembly 211 and a stabilizing member mount 219 mounted to the vehicle frame 203 such as on a cross-member 209 or other structural support on the underside of the vehicle 202 laterally inward under the vehicle 202 relative to the pivot mount 213.

The telescoping lift leg assembly 211 includes upper and lower telescoping tubes 221 and 222. A linear actuator (not shown), which may be hydraulically or electrically powered, is connected between the upper and lower telescoping tubes 221 and 222 to extend and retract the lower tube 222 relative to the upper tube 221. A foot or foot pad 224 is secured to the lower end 217 of the lower tube 222 which may also be described as the lower end of the lift leg assembly 217. The foot pad may be shaped as a round disk centered on the distal end of the lower tube 222.

The upper telescoping tube 221 is mounted to a pivot block or pivot member 226 which is pivotally connected to a clevis or clevis type bracket 228 which is mounted to the vehicle frame and preferably to the left or right side frame member 208. One set of jack assemblies 201 is mounted to the left and right side frame members 208 in lateral alignment behind the wheels 206 or proximate rear corners of the vehicle 202, and another set of jack assemblies 201 is preferably mounted to the left and right side frame members 208 in lateral alignment proximate the front corners of the vehicle 202. The pivot block 226 may be pivotally connected to the clevis 228 with a pivot pin 230. The pivot block 226, clevis 228 and pivot pin 230 form a hinge assembly or pivot assembly 213 pivotally connecting the lift leg assembly 211, to the vehicle frame 203 and in the embodiment shown the side frame member 208. In the embodiment shown the upper segment or cylinder 221 of the lift leg assembly 211 is pivotally mounted to the side frame member 208 by hinge assembly 213.

A stabilizing member or brace 215 may be formed from a channel member, pivotally connected at an outer end 233 to the lower end 217 of the lower tube 222 or lower end of the lift leg assembly 211. An inner end 235 of the stabilizing member 215 is pivotally connected to the stabilizing member mount 219.

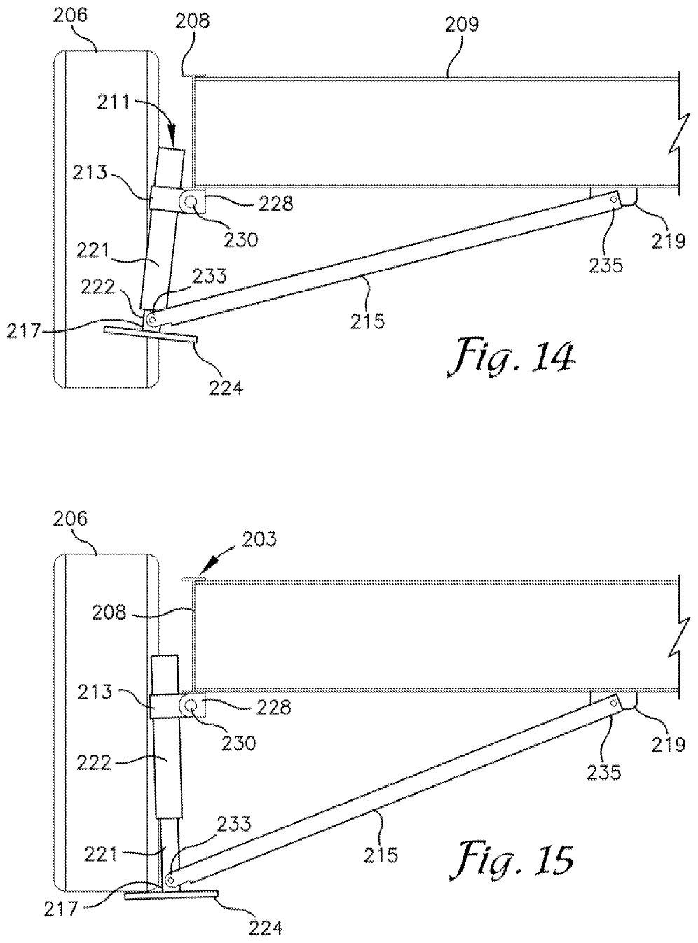

Referring to FIG. 14, the stabilizing jack 201 is shown in a retracted position, in which the lower tube or segment or piston 222 of the telescoping lift leg assembly 211 is retracted into the upper tube or segment 221, lifting foot pad 224 off the ground. As the lower segment 222 retracts, the fixed length of the stabilizing member 215 and the hinged connection of the lift leg assembly 211 to the side frame 208 causes a lower end 217 of the lift leg assembly 211 to pivot outward about the pivot pin 230 of the hinge assembly 213. Upon extension of the lower segment or piston 222 to advance the foot pad 224 into engagement with the ground, the fixed length stabilizing member 215 pulls or causes the lower end 217 of the lift leg assembly 211 and foot pad 224 to pivot inward.

As the telescoping leg 211 continues to extend after the foot pad 224 engages the ground, the lift leg 14 will lift the vehicle frame 203 to lift the vehicle frame 203 relative to the suspension so that the portion of the frame 203 to which the jack 201 is connected is supported off the suspension and on the jack 201. The foot pad 224 is preferably formed with a relatively large surface area to allow it to slide inward on the ground as the telescoping leg 211 is extended, after the foot pad 224 engages the ground, due to the inward pull on the lower end 217 of the telescoping leg 211 from the fixed length stabilizing member or brace 215. The foot 224 is preferably formed round to reduce corners that might catch or dig into the ground and resist movement of the foot pad 224 relative to the ground as it is pulled inward by brace 215 upon extension of the telescoping leg 211 or pushed outward by brace 215 upon retraction of the telescoping leg 211.

When jacks 201 mounted to the frame 203 proximate the four corners thereof are extended the entire frame 203 may be raised upward relative to the suspension to support the frame relative to the ground and off the suspension. Lateral alignment of two jacks 201 on opposite sides of the vehicle provides considerably lateral stability with at least some of the lateral forces being transmitted through the angled braces 215 of the aligned jacks 201.

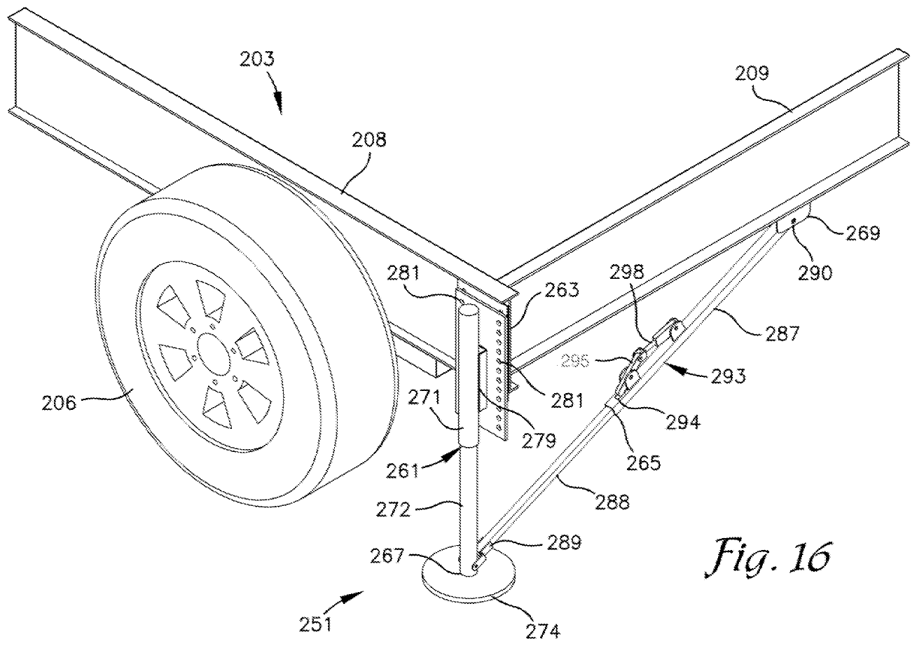

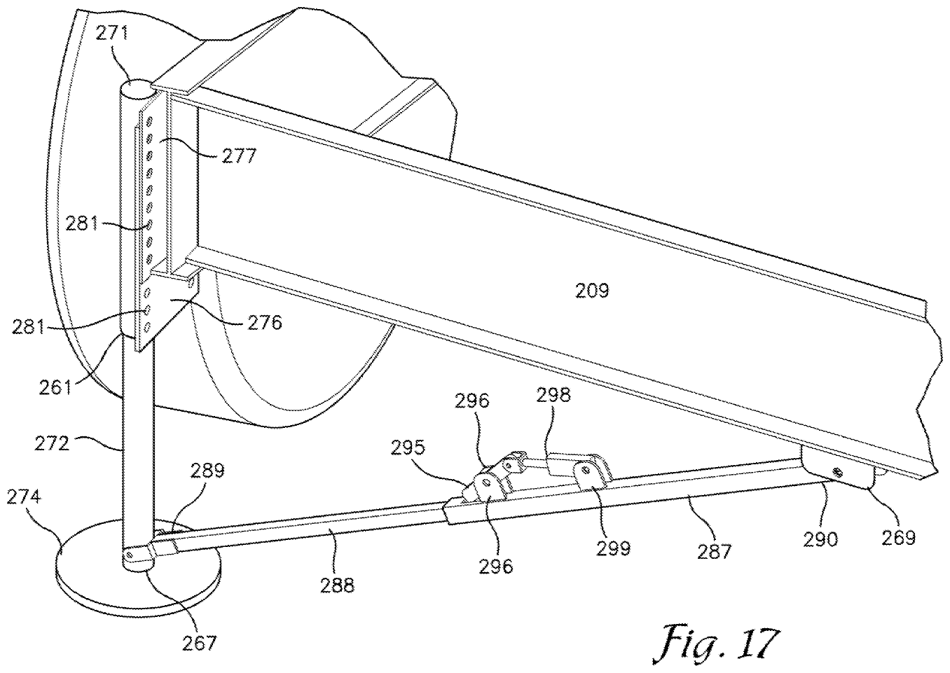

Referring to FIGS. 16 and 17, a further alternative embodiment of a stabilizing jack assembly 251 is shown which may also be sized to function as a leveling jack to level a recreational vehicle as represented by the vehicle frame 203 supported on wheels 206 by a suspension (not shown). Jack assembly 251 includes a lift leg assembly or linear actuator 261 connected to a vehicle frame member such as side frame member 208 by a height adjustable mount 263. A stabilizing member 265 is connected to and extends between a lower end 267 of the lift leg assembly 261 and a stabilizing member mount 269 mounted to the vehicle frame 203 such as on a cross-member 209 or other structural support on the underside of the vehicle 202 laterally inward under the vehicle 202 relative to the mounting plates 263.

In the embodiment shown, the lift leg assembly 261 includes telescoping tubes 271 and 272 and a linear actuator (not shown), which may be hydraulically or electrically powered, connected between the upper and lower telescoping tubes 271 and 272 to extend and retract the lower tube 272 relative to the upper tube 271. A foot or foot pad 274 is secured to the lower end 267 of the lower tube 272 which may also be described as the lower end of the lift leg assembly 267. The foot pad may be shaped as a round disk centered on the distal end of the lower tube 272.

The height adjustable mount 263 in the embodiment shown comprises first and second mounting plates 276 and 277. The upper telescoping tube 271 is mounted on the first mounting plate 276 by a mounting bracket or block 279 and the second mounting plate 277 is connected to the vehicle frame and preferably the left or right side frame member 208. One set of jack assemblies 201 is mounted to each of the left and right side frame members 208 in lateral alignment behind the wheels 206 or proximate rear corners of the vehicle 202, and another set of jack assemblies 201 is preferably mounted to each of the left and right side frame members 208 in lateral alignment proximate the front corners of the vehicle 202. Formed in each mounting plate 276 and 277 are at least two sets or columns of bolt holes 281. The bolt holes 281 in each column extend in vertically spaced relationship and are laterally aligned with the bolt holes 281 of the adjacent column. Mounting plate 276 is positioned flush against mounting plate 277 and slidable vertically relative thereto to bring laterally aligned pairs of bolt holes 281 in mounting plate 276 into overlapping alignment with pairs of bolt holes 281 in mounting plate 277 so that bolts may be extended through aligned sets of bolt holes 281 and secured in place with nuts. In this manner the vertical position of the upper tube 271 of each telescoping lift leg assembly 261 is adjustable vertically to accommodate different spacings between the trailer frame 203 and the ground.

In the embodiment shown in FIGS. 16 and 17, the stabilizing member or brace 265 is formed as a length adjustable or telescoping assembly formed from first and second telescoping members 287 and 288. A stabilizing member 265 is pivotally connected at an outer end 289 to the lower end 267 of the lower tube 272 of the lift leg assembly 261. An inner end 290 of the stabilizing member 265 is pivotally connected to the stabilizing member mount 269.

A latch or locking member 293 is formed on one of the first and second telescoping members 287 and 288. In the embodiment shown, the latch 293 is mounted on the outer telescoping member 287 and selectively engages the inner telescoping member 288 through a hole 294 in the outer telescoping member 287 to prevent movement of the inner telescoping member 288 relative to the outer telescoping member 287. The latch 293 includes a latch bar or latch member 295 pivotally mounted on a first clevis 296 on the outer telescoping member 287 proximate or adjacent the access hole 294. A rear end of the latch bar 295 opposite the access hole 294 is pivotally connected to a linear actuator 298. An end of the actuator 298 opposite its connection to the latch bar 295 is pivotally connected to a second clevis 299 mounted on the outer telescoping member 287 in space relation from the first clevis 296 on a side opposite the access hole 294. Extension of the linear actuator 298 pivots a forward end of the latch bar 295 through the access hole 294 and into engagement with a portion of the inner telescoping member 288 extending within the outer telescoping member 287 to frictionally secure the position of the inner telescoping member 288 relative to the outer telescoping member 287. Retraction of the linear actuator 298 pivotally withdraws the forward end of the latch bar 295 from the access hole 294 and out of engagement with the inner telescoping member 288 to allow the inner telescoping member 288 to slide relative to the outer telescoping member 287. The actuator 298 is preferably remotely operable to disengage the latch bar 295 prior to extension or retraction of the telescoping lift leg assembly 261 to allow the stabilizing member 265 to slidingly extend and retract simultaneously with the lift leg assembly 261. When the lift leg assembly 261 is extended so that the foot pad 274 engages the ground and then lifts the frame relative to the suspension and to a desired height to also level the frame, the actuator 298 is remotely extended to fix the length of the stabilizing member 265 and provide lateral support for the vehicle 4 relative to the lift leg assembly 261.

The linear actuator 298 may be an electrically operable solenoid or a hydraulic actuator. It is foreseen that instead of using a separate latch 293, a linear actuator, such as a hydraulic actuator could be integrated into the extendable stabilizing member 265 to retract and extend the stabilizing member 265 and then fix its relative length once the lift leg assembly 261 is extended to a desired length.

When jacks 251 mounted to the frame 203 proximate the four corners thereof are extended the entire frame 203 may be raised upward relative to the suspension to support the frame relative to the ground and off the suspension. Lateral alignment of two jacks 251 on opposite sides of the vehicle 4 with the associated stabilizing members 265 engaged by and fixed in length by the associated latches 293 provides considerably lateral stability with at least some of the lateral forces being transmitted through the angled braces 265 of the aligned jacks 251.

It is to be understood that while certain forms of the described embodiments have been illustrated and described herein, the invention is not to be limited to the specific forms or arrangement of parts described and shown. As used in the claims, identification of an element with an indefinite article “a” or “an” or the phrase “at least one” is intended to cover any device assembly including one or more of the elements at issue. Similarly, references to first and second elements is not intended to limit the claims to such assemblies including only two of the elements, but rather is intended to cover two or more of the elements at issue. Only where limiting language such as “a single” or “only one” with reference to an element, is the language intended to be limited to one of the elements specified, or any other similarly limited number of elements.

1. A stabilizing jack for use with a vehicle comprising:
a length adjustable lift leg pivotally connected proximate an upper end to a lift leg pivot mount; and
a stabilizing member pivotally securable at a first end to a stabilizing member mount securable to a vehicle frame inward from the lift leg pivot mount, the stabilizing member connected at a second end to a lower end of the lift leg.

2. A stabilizing jack according to claim 1, wherein the length adjustable lift leg comprises a linear actuator.

3. A stabilizing jack according to claim 1, wherein the lift leg pivot mount includes a first mounting member fixedly secured to the vehicle frame and a second mounting member pivotally connected to the first mounting member, and the lift leg is connected to the second mounting member.

4. A stabilizing jack according to claim 1, further comprising a foot mounted on a lower end of the length adjustable lift leg.

5. A stabilizing jack for use with a vehicle comprising:
a base securable to the vehicle and having inner and outer ends;
a drive screw rotatably mounted to the base;
a screw follower threadingly secured to the drive screw for linear advancement of the screw follower longitudinally relative to the drive screw upon rotation of the drive screw;
a stabilizing member pivotally connected at a first end to the base inward from the screw follower; and
a length adjustable lift leg pivotally connected at an inner end to the screw follower and pivotally connected at an outer end to the stabilizing member.

6. A stabilizing jack according to claim 5, wherein the length adjustable lift leg comprises a telescoping leg assembly and means for selectively fixing a length of the telescoping leg assembly.

7. A stabilizing jack according to claim 5, wherein the length adjustable lift leg comprises:
a first segment pivotally connected at a first end to the screw follower and a second segment telescopingly secured to the first segment at a first end and pivotally connected to the stabilizing member at a second end; and
means for selectively fixing a telescoped position of the second segment relative to the first segment.

8. A stabilizing jack according to claim 5, further comprising a motor drivingly coupled to the drive screw and operable to rotate the drive screw clockwise and counterclockwise.

9. A stabilizing jack according to claim 5, further comprising a motor drivingly coupled to an end of the drive screw extending proximate the outer end of the base and a switch mounted on the base proximate the outer end thereof and operably coupleable to the motor and a power source, the switch normally advanced to an off position in which power is not supplied to the motor from the power source, the motor selectively advanceable to a first power supply position in which power is supplied to the motor from the power source to rotate the drive screw in a first direction and to a second power supply position in which power is supplied to the motor from the power source to drive the drive screw in a second direction.

10. A stabilizing jack according to claim 9, wherein the motor is an electric motor electrically coupleable to a battery on a vehicle on which the stabilizing jack is mounted.

11. A stabilizing jack according to claim 9, wherein the motor is coupled to the drive screw such that an axis of rotation of the motor extends approximately perpendicular to the axis of rotation of the drive screw.

12. A stabilizing jack according to claim 11, wherein the switch is mounted on an outer end of the base.

13. A stabilizing jack according to claim 5, further comprising a motor coupled to the drive screw such that an axis of rotation of the motor extends approximately perpendicular to the axis of rotation of the drive screw.

14. A stabilizing jack according to claim 5, further comprising a motor mounted on a motor mount removably securable to the base of the stabilizing jack with a driver of the motor drivingly coupled to the drive screw and operable to rotate the drive screw clockwise and counterclockwise.

15. A stabilizing jack according to claim 5, further comprising a motor mounted on a motor mount removably securable to the base of the stabilizing jack with a driver of the motor drivingly coupled to an end of the drive screw extending proximate the outer end of the base and a switch mounted on the base proximate the outer end thereof and operably coupleable to the motor and a power source, the switch normally advanced to an off position in which power is not supplied to the motor from the power source, the motor selectively advanceable to a first power supply position in which power is supplied to the motor from the power source to rotate the drive screw in a first direction and to a second power supply position in which power is supplied to the motor from the power source to drive the drive screw in a second direction.

16. A stabilizing jack according to claim 15, wherein the motor is mounted on the motor mount such that when the motor mount is secured to the base and the driver is coupled to the end of the drive screw, an axis of rotation of the motor extends approximately perpendicular to the axis of rotation of the drive screw.

17. A stabilizing jack for use with a vehicle comprising:
a base securable to the vehicle and having inner and outer ends;
a drive screw rotatably mounted to the base;
a screw follower threadingly secured to the drive screw for linear advancement of the screw follower longitudinally, inward or outward relative to the drive screw upon rotation of the drive screw in first or second directions, respectively;
a leg pivotally connected at an inner end to the screw follower;
a brace pivotally connected at a first end to the leg and at a second end to the base and operable to pivot the leg downward as the screw follower advances outward relative to the drive screw and to pivot the leg upward as the screw follower advances inward relative to the drive screw; and
a motor drivingly coupled to an end of the drive screw extending proximate the outer end of the base and a switch mounted on the base proximate the outer end thereof, the switch operably coupleable to the motor and a power source, the switch is selectively advanceable between an off position in which power is not supplied to the motor from the power source, a first power supply position in which power is supplied to the motor from the power source to rotate the drive screw in the first direction or a second power supply position in which power is supplied to the motor from the power source to drive the drive screw in the second direction.

18. A stabilizing jack according to claim 17, wherein the motor is an electric motor electrically coupleable to a battery on a vehicle on which the stabilizing jack is mounted.

19. A stabilizing jack according to claim 17, wherein the motor is coupled to the drive screw such that an axis of rotation of the motor extends approximately perpendicular to the axis of rotation of the drive screw.

20. A stabilizing jack according to claim 19, wherein the switch is mounted on an outer end of the base.

21. A stabilizing jack for use with a vehicle comprising:
a base securable to the vehicle and having inner and outer ends;
a drive screw rotatably mounted to the base;
a screw follower threadingly secured to the drive screw for linear advancement of the screw follower longitudinally, inward or outward relative to the drive screw upon rotation of the drive screw in first or second directions respectively;
a leg pivotally connected at an inner end to the screw follower;
a brace pivotally connected at a first end to the leg and at a second end to the base and operable to pivot the leg downward as the screw follower advances outward relative to the drive screw and to pivot the leg upward as the screw follower advances inward relative to the drive screw; and
a motor mounted on a motor mount removably securable to the base of the stabilizing jack with a driver of the motor drivingly coupled to an end of the drive screw extending proximate the outer end of the base and a switch mounted on the motor mount proximate the outer end thereof, the switch operably coupled to the motor and operably coupleable to a power source, the switch is selectively advanceable between an off position in which power is not supplied to the motor from the power source, a first power supply position in which power is supplied to the motor from the power source to rotate the drive screw in the first direction, or a second power supply position in which power is supplied to the motor from the power source to drive the drive screw in the second direction.

22. A stabilizing jack according to claim 21, wherein the motor is an electric motor electrically coupleable to a battery on a vehicle on which the stabilizing jack is mounted.

23. A stabilizing jack according to claim 21, wherein the motor is coupled to the motor mount such that an axis of rotation of the motor extends approximately perpendicular to the axis of rotation of the driver.

24. A stabilizing jack according to claim 23, wherein the switch is mounted on an outer end of the motor mount.
